(19) United States
(12) Patent Application Publication
(10) Pub. No.: US 2006/0072539 A1
(43) Pub. Date: Apr. 6, 2006

(54) Method and device for synchronizing a receiver with a transmitter during a transmission of data over an asynchronous network

(76) Inventor: Juergen Busch, Buechenbach (DE)

Correspondence Address: QUARLES & BRADY LLP, 411 E. WISCONSIN AVENUE, SUITE 2040, MILWAUKEE, WI, 53202-4497, US

(21) Appl. No.: 10/512,251

(22) PCT Filed: Apr. 17, 2003
(86) PCT No.: PCT/EP03/04011

§ 371 Date: Nov. 7, 2005

(30) Foreign Application Priority Data
Apr. 24, 2002 (DE) 102 18 425.9

(51) Int. Cl. H04J 3/06

(52) U.S. Cl. 370/350; 370/503

(57) ABSTRACT

The invention relates to a method and device for synchronizing a receiver with a transmitter during a transmission of data over an asynchronous network. The data are transmitted in the form of data packets from the transmitter to the receiver via a transmission medium. An item of time information derived from a time base is inserted into the data packets. This item of time information contains information concerning the exact time at which a previously transmitted data packet was sent off. Inside the receiver, the time basis thereof is corrected by comparing the time information generated by the transmitter with an item of time information, which is generated in the receiver and temporarily stored therein.

The invention concerns a method and device for synchronizing a receiver with a transmitter during a transmission of data over an asynchronous network.

A method and a system for controlling and for exchange of data in multimedia equipment are known from DE 199 61 644 A1. The individual equipment, especially equipment of entertainment electronics are connected together through a bus. Each activated equipment sends information through the bus to the other activated equipment within a predetermined period of time. With the aid of these messages, the other activated equipment can recognize if a particular equipment is activated or not. If, after a predetermined period of time no report is received, then the other equipment recognizes that the particular equipment is no longer active. An equipment which is activated for the first time or repeatedly, sends its own information through the bus to the other activated equipment only after a period of time which is greater than or equal to the predetermined time.

A method and a device for time synchronous forwarding of signals is known from WO 02/01878 A1. Here signals from at least one signal source are transferred through different signal paths to at least one signal sink. Time marks are introduced into the various signals. In order to achieve time-synchronous forwarding of signals to the sinks, all the delays that occur in the different signal paths are determined and a minimum total delay is calculated from the determined delays which is greater than or equal to the delay which occurs in the signal path with the largest delay. The time marks introduced into the various signals contain information about the minimum total delay. An individual delay is imposed in each signal path to the signal to be transferred and this delay corresponds to the difference between the minimum total delay and the delay that is imposed due to signal processing on the signal in the particular signal path.

In many network standards, data can be sent only when the transfer medium has been free over a certain time period. Such a procedure is known under the designation CDMA (carrier sense multiple access). In such systems, it cannot be predicted as to what time a data packet will actually be sent through the transmission medium. This property has unfavorable effects on the transmission of time marks, for example as they are used in NTP and RTP protocols of IETF when the transmitting circuit is not able to insert the time stamp of the actual transmitting time point into the packet to be transferred.

Starting from this state of the art, the task of the invention is to show a way in which the correct transmitting time point of a data packet can be determined.

This task is solved by a method with the characteristics given in claim 1 and by a device with the characteristics given in claim 3.

Advantageous embodiments and further developments of the invention are given in the dependent claims.

The advantages of the invention consist especially in the fact that the particular receiver is able to synchronize its time base more rapidly and more accurately to the time base of the transmitter.

Other advantageous properties of the invention follow from their explanation on an example with the aid of the figures. The following are shown:

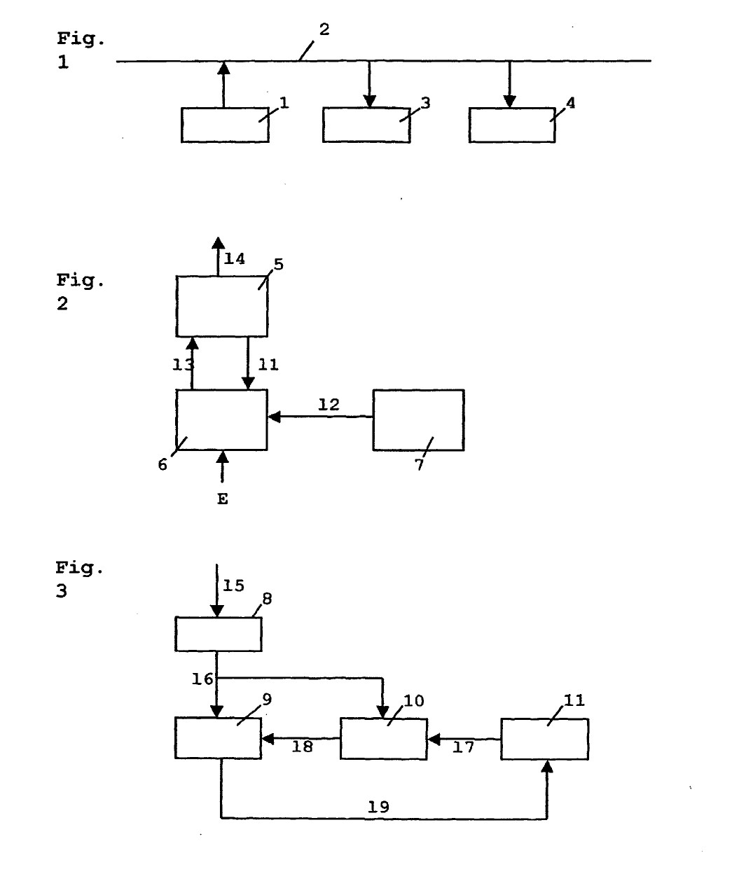

FIG. 1 is a circuit diagram of a device for the transmission of data through a transmission medium,

FIG. 2 is a circuit diagram to explain the structure of the transmitter and

FIG. 3 is a circuit diagram to explain the structure of a receiver.

FIG. 1 shows a circuit diagram of a device for the transmission of data through a transmission medium. The device shown has a transmitter 1 which transmits data through a transmission medium 2 to receivers 3 and 4. The transmission medium 2 can be a wired medium or a wireless medium. The data are transmitted in data packets. Time information produced in the transmitter is contained in each transmitted data packet.

FIG. 2 shows a circuit diagram to explain the structure of the transmitter 1. The transmitter shown has a transmitting stage 5, a packetizer 6 and a time base 7. The transmitting stage 5 is provided to make the data packets to be sent available which are then forwarded through connection |4 to the transmission medium 2 shown in FIG. 1. The data packets to be transmitted are generated in the packetizer 6, which has an input connection E at which the data to be transmitted are available in the form of a data stream.

Furthermore, the packetizer 6 receives through a connection |1 an echo provided by transmitting stage 5 and time information produced by the time base 7 of the transmitter through connection |2. The echo is always formed by transmitting stage 5 when a data packet was sent successfully. As soon as the packetizer 6 receives the echo, it introduces the actual time information delivered through connection |2 into the next data packet to be sent, as a time mark. This data packet will then be forwarded to transmitting stage 5 and transmitted through the transmission medium 2 to receivers 3 and 4 at a time point determined by the particular existing network standard.

Consequently, a time mark is inserted into each transmitted data packet, the time mark being derived from the time base 7 of the transmitter and containing accurate information about the transmitting time of a data packet sent previously in time.

FIG. 3 shows a block diagram for explaining the structure of a receiver. The receiver shown has a receiving stage 8, a comparator 9, a memory 10, preferably designed as a FIFO and its own time base 11. With the aid of the receiving stage 8, the data packets transmitted through the transmitting medium 2 and connection |5 are received. As soon as a receiving stage 8 has received a data packet, it reports this through connection |6 to comparator 9 and memory 10. As a reaction to this message signal, it stores a time information derived from the time base 11 of the receiver, which consequently contains information about the time of receiving of the data packet just received.

Another time information is also already deposited in memory 10 which was formed upon receipt of the data packet received previously in time and consequently contains information about the time of receiving of the data packet that was received previously in time.

When the above message signal is received, then memory 10 transmits the already-stored additional time information to comparator 9 through connection |8. This compares the time information separated from the data packet just received with the time information derived from memory 10 and transmitted to it through connection |8. Both such time information refer to the data packet received previously, whereby the time information derived from the transferred data packet describes the time of sending of the previously sent data packet and the time information provided by memory 10 describes the time of receiving of the previously sent data packet.

Assuming that there are no delays due to running time or transmission or that any such delay times are known and are stored in comparator 9, comparator 9 forms a difference signal from the time information data provided to it. With the aid of this difference signal, the local time base 11 of the receiver is corrected through connection |9 and thus the receiver is synchronized with the transmitter.

In this way, other receivers connected to the transmission medium 2 can be synchronized with the transmitter.

According to all this, in the practical example described above the correction transmission time of a data packet is determined in retrospect. This makes it possible for a receiver to synchronize its time base rapidly and accurately with the time base of the transmitter.

Alternatively to the practical example described above, it is also possible to transmit in each transmitted data packet a “conventional” time mark and in addition to that to transfer correction signals for the time marks contained in the previous data packet, whereby the correction signals contain accurate information about the transmission time of the previous data packet. This solution has the advantage that compatibility to the previous standard exists and that receivers which can evaluate the correction values can profit from the advantages of the invention described above.

### REFERENCE LIST

1 Transmitter
2 Transmission medium
3 1^{st} receiver
4 2^{nd} receiver
5 Transmitting stage
6 Packetizer
7 Time base of the transmitter
8 Receiving stage
9 Comparator
10 Memory
11 Time base of the receiver
   |1 . . . |9 Connections
E Input connection

1. Method for the synchronization of a receiver with a transmitter during data transmission through an asynchronous network, whereby the data are transmitted in the form of data packets from the transmitter through a transmission medium to the receiver and whereby the data packets contain time information produced with the aid of a time base of the transmitter, with the following process steps:
sending a first data packet by the transmitter,
receiving the first data packet by the receiver,
storage of a time information derived from the time base of the receiver, which contains information about the time of receiving the first data packet,
insertion of a time information derived from the time base of the transmitter containing information about the time of sending of the first data packet, into a second data packet,
transmitting the second data packet by the transmitter,
receiving the second data packet by the receiver,
separation of the time information derived from the time base of the transmitter which contains information about the time of sending the first data packet, from the second data packet, and
Adjustment of the time base of the receiver to the time base of the transmitter using the separated time information derived by the transmitter and the stored time information derived by the receiver.

2. Method according to claim 1,
characterized by the fact that
the time base of the receiver is corrected as a function of a difference signal obtained within the framework of a comparison of the time information.

3. Method according to claim 1 or 2,
characterized by the fact that
the data packets sent by the transmitter contain time information in the form of time marks, which have information about the time of sending a previously transmitted data packet.

4. Method according to claim 1 or 2,
characterized by the fact that
the data packets sent by the transmitter contain time information which consists of time marks and correction signals, whereby the correction signals contain information about the time of sending a previously transmitted data packet.

5. Device for synchronization of a receiver with a transmitter during data transmission through an asynchronous network, with a transmitter (1), a transmission medium (2) and a receiver (3, 4),
whereby the transmitter (1) has the following:
a time base (7) for producing time information,
a packetizer (6) connected to the time base which is provided for producing data packets in which time information derived from the time base (7) of the transmitter is inserted, which contains information about the time of sending of a previously transmitted data packet, and
a transmitting stage (5) connected to the packetizer (6) for sending the data packets produced by the packetizer,
and whereby the receiver (3, 4) has the following:
a receiving stage (8) for receiving the data packets,
a time base (11) for producing time information,
a memory (10) connected to the time base (11) for storing time information which contains information about the time of receipt of a data packet,
a separating stage (8) for separating the time information produced by the time base of the transmitter which contains information about the time of sending of a previously-transmitted data packet, from a received data packet, and
an adaptation stage for adaptation of the time base (11) of the receiver to the time base (7) of the transmitter using the separated time information produced by the transmitter and the stored information produced in the receiver.

6. Device according to claim 5,
characterized by the fact that
the adaptation stage contains a comparator (9) which determines a difference signal provided for correcting the time base (11) of the receiver by comparison of the separated time information produced by the transmitter and the stored time information produced in the receiver.

7. Method according to claim 5 or 6, characterized by the fact that the memory (10) is a FIFO memory.
